(19) United States
(12) Patent Application Publication
(10) Pub. No.: US 2003/0103469 A1
(43) Pub. Date: Jun. 5, 2003

(54) Method and apparatus for controlling the transmission power in radio communications system

(76) Inventors: David Setty, Hampshire (GB); Volker Sommer, Berlin (DE); Stefan Oestreich, Holzkirchen (DE); Gerald Lehmann, Berlin (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/149,976

(22) PCT Filed: Dec. 15, 2000
(86) PCT No.: PCT/GB00/04819

(30) Foreign Application Priority Data
Dec. 15, 1999 (GB) 9929577.6
Oct. 3, 2000 (GB) 0024105.9

(51) Int. Cl. H04J 3/00

(52) U.S. Cl. 370/280; 370/314

(57) ABSTRACT

The present invention provides a method for controlling the transmission power requirements in a time division duplex wireless telecommunication system. The method uses the size of the data and Midamble in a burst and the change in rate matching to control the transmission power.

The present invention relates to a method and apparatus for controlling the transmission power in a telecommunications system. More specifically, the present invention relates to a method and apparatus for controlling the transmission power in a Time Division Duplex (TDD) wireless telecommunication system based on a relationship between the size of the Midamble and the size of the data in a transmission burst.

It is currently known to perform rate matching in a wireless telecommunication system. During this process the rate of the data transmission in a burst from a base station is matched in order to obtain optimum system performance. The two methods currently used to perform rate matching are repetition and punctuation, both of which are well known in the field of wireless telecommunications. In order to maintain the same bit error rate (BER) during rate matching the transmission (Tₓ) power requirement changes. For example, if repetition is used the Tₓ power requirement is reduced, whereas if puncturing is used the Tₓ power requirement is increased. Thus when rate matching is applied the Tₓ power must be adjusted accordingly in order to maintain a minimum BER and to thereby keep intercell interference to a minimum.

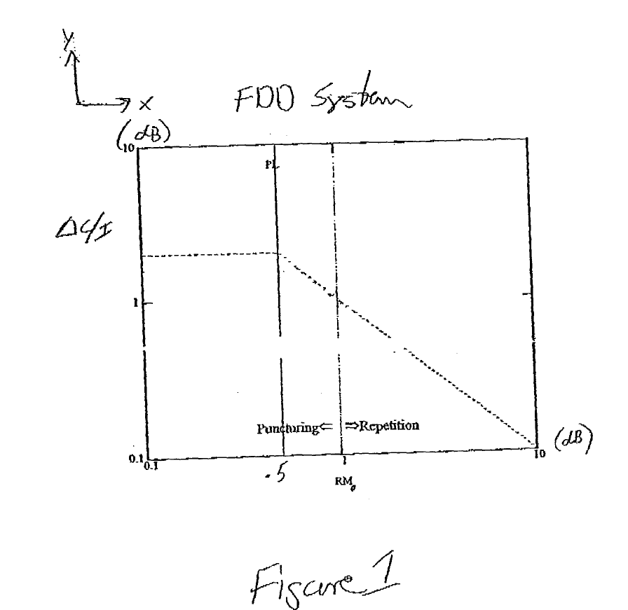

It is known within frequency division duplex (FDD) wireless telecommunications system to adjust the Tₓ power by 1/RM, where RM is the rate matching value. As is shown in FIG. 1, this results in a linear relationship between the Tₓ power requirement represented on the Y axis of the graph by Δ C/I , and the rate matching value represented on the X axis of the graph by RM. The initial rate matching value (RM_{O}) is equal to one. As can be seen from the graph, if puncturing is used during rate matching the Tₓ power requirement increases. Similarly, if repetition is used during rate matching the Tₓ power requirement decreases.

Currently there are no provisions for controlling the Tₓ power in a TDD wireless telecommunication system.

It is an object of the present invention to provide a method for controlling the Tₓ power during the rate matching in a TDD system. Advantageously, by reducing the Tₓ power requirements during rate matching, the overall power requirements of the wireless telecommunication system and the system's costs are reduced.

According to the present invention there is provided a method for controlling the transmission power in a time division duplex wireless telecommunication system comprising the step of adjusting the transmission power of the system according to a relationship between the size of the Midamble signal and the size of the data signal within a transmission burst.

According to an aspect of the present invention said relationship between the size of the Midamble signal (M) and the size of data signal (D) within said transmission burst is a slope (S).

According to further aspect the method comprises the further steps of determining change in rate matching (ΔRM) used within said tireless telecommunication system, determining a minimum transmission power level required to maintain a predetermined ratio of carrier signal power to interference signal power, and adjusting said transmission power according to said slope and said change in rate matching.

According to a yet further aspect of the present invention said predetermined ratio of carrier signal power to interference signal power includes a guard level.

According to a still further aspect of the invention there is provided apparatus for controlling the transmission power in a time division duplex wireless telecommunication system comprising the step of:

adjusting the transmission power of the system according to a relationship between the size of a Midamble signal and the size of a data signal with a transmission burst.

While the principle advantages and features of the invention have been described above, a greater understanding and appreciation of the invention may be obtained by referring to the drawings and detailed description of a preferred embodiment, presented by way of example only, in which;

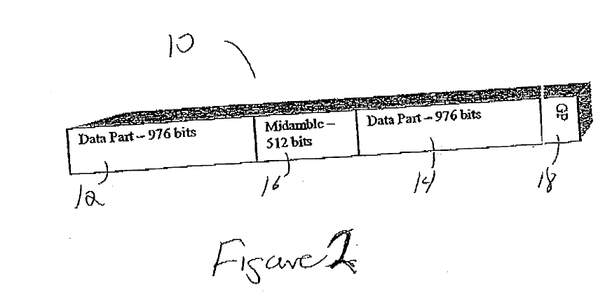

FIG. 2 is an example of a burst structure;

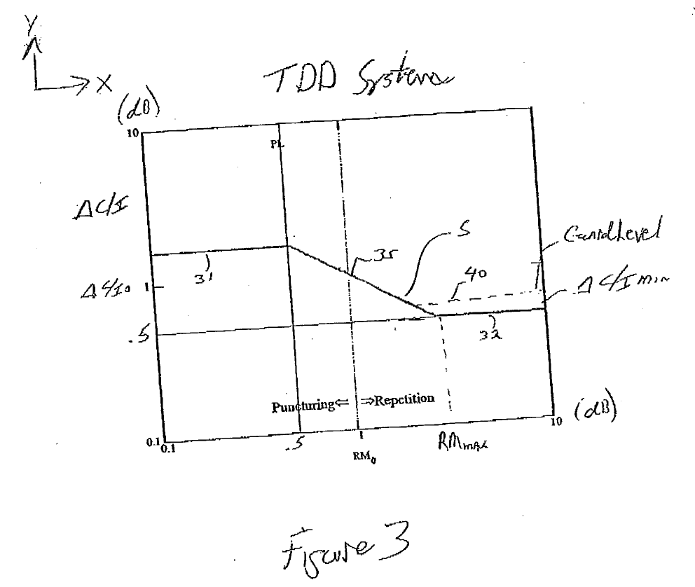

FIG. 3 is a graph which shows the relationship of transmission power to rate matching in a TDD system.

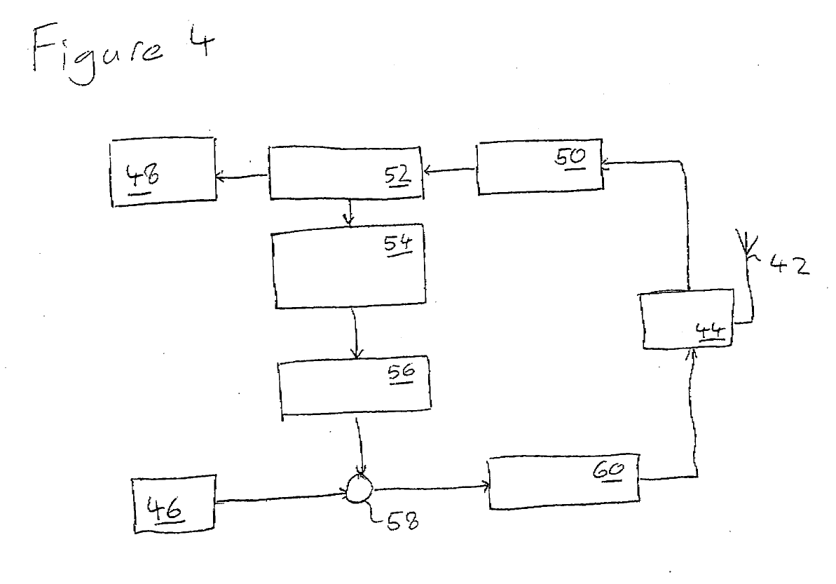

FIG. 4 shows a partial handset architecture in accordance with the invention; and,

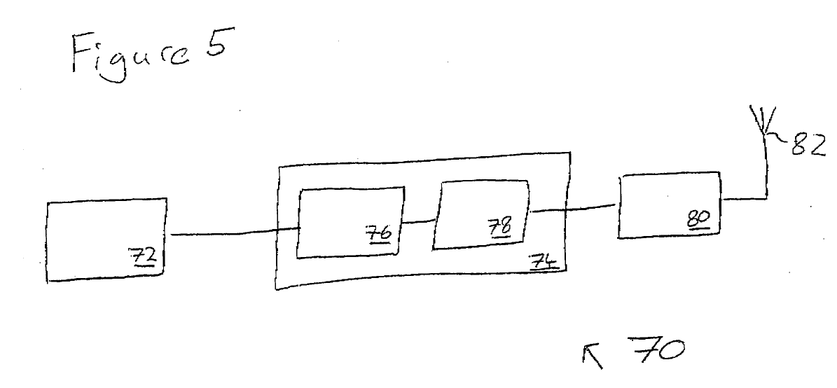

FIG. 5 shows a partial base station architecture in accordance with the invention.

In order to fully understand the present invention, a specific example will now be given with reference to FIGS. 2 and 3.

FIG. 2 shows the structure of a typical burst signal 10. The burst signal consists of two data parts 12 and 14, a Midamble part 16, and a guard period 18. Each data part consists of 976 bits and the Midamble consists of 512 bits. The guard period consists of N bits, where N is an integer number. As will be appreciated by the skilled man, the sizes of the data parts, Midamble and guard period may vary according to the wireless telecommunication system's particular requirements. It will also be appreciated that the structure may not contain a guard period.

According to the present invention the Tₓ power of a mobile phone is changed based on the following factors: a puncturing limit value, a minimum carrier signal power to interference signal power ratio, and the amount of data in the burst. The minimum carrier signal power to interference signal power ratio may include a guard level.

A maximum Tₓ power is set according to a puncturing limit (PL). The value of PL is set at the maximum amount of puncturing which a signal can withstand. Any puncturing beyond this value results in a signal which has lost too much data to be successfully interpreted. The PL is determined by the rate matching parameters of the telecommunication system and is transmitted from the base station to user equipment, such as a mobile phone.

A minimum Tₓ power is set according to a minimum value of the ratio of carrier signal power to interference signal power (C/I min) in which the system can still function properly. The value of C/I min may be predefined based on knowledge of the system or it may be transmitted by the base station and be derived from previous values of C/I min, or be an estimation. This ratio may include a guard level which functions to insure that the minimum Tₓ power level is never reached.

The amount of data in the burst is then compared to the amount of Midamble bits. As will be appreciated, this value may vary considerably and each burst must be evaluated individually.

The amount in which the Tₓ power can be reduced or increased is then calculated. The maximum amount the Tₓ power can be increased by is preferably set at the PL value. Increasingly the Tₓ power beyond the PL value will not improve the system's performance as the amount of data lost due to the puncturing process determines the point of system failure. Furthermore, the minimum level to which the Tₓ power can be reduced is preferably set at the C/I min value previously discussed. The C/I min value may include a guard level. Alternatively, the maximum and minimum Tₓ power levels may tend towards an asymptote at these values. For the region between the maximum and minimum Tₓ power levels, the value of the Tₓ power is calculated according to a relationship between the size of the data and the size of the Midamble in each burst.

FIG. 3 shows a graph of the specific example of the present invention with the X axis representing the value of the rate matching (RM) and the Y axis representing the change in the value of the ratio of the carrier signal power to interference signal power (Δ C/I ). As will be appreciated an increase in Tₓ power will result in an increase in the power of the carrier signal and thus an increase in the value of Δ C/I.

For this specific example the value of Δ C/I min is predetermined and transmitted by the base station. Additionally, the PL value is predetermined and may also be transmitted by the base station. The maximum and minimum Tₓ power levels are depicted on the graph in FIG. 3 by the solid lines 31 and 32 respectively. In this specific example the value of Δ C/I min is equal to 0.5 dB and the, value of PL is equal to 0.5 dB.

In an enhancement to the specific example shown in FIG. 3 a guard level 40 is included. This has the effect of increasing the minimum level to which the Tₓ power can be reduced.

For the region between the PL and the Δ C/I min the rate of change of Tₓ power is determined according to the amount of data in the burst (D) and the size of the Midamble (M). The rate of change is constant and is shown graphically in FIG. 3 by slope S. The slope is calculated according to equation 1:

$$S = \frac{( M - D )}{D} \qquad Equation 1$$

For the burst shown in FIG. 2, where D equals 1952 and M equals 512, S equals −0.738. Thus a negative slope will exist provided the data component of the burst is greater than the Midamble component. As previously explained and shown in FIG. 1, in an FDD system where not Midamble exists, the slope equals −1.

The amount the Tₓ power is increased or decreased can then be calculated according to the following set of rules. The change in Tₓ power is shown graphically in FIG. 3 as Δ C/I and is calculated in decibels (dB).

The initial value of the rate matching (RM_{O}) is equal to 1. This corresponds to an initial Δ C/I (Δ C/I_{O}) value of 1. The point of intersection of RM_{O} and Δ C/I _{O} is shown in FIG. 3 by reference numeral 35. The new value of rate matching is denoted as RM_{N}. When the Δ C/I min value is reached, the rate matching at that point is denoted by RMₘₐₓ. As will be appreciated, the rate matching (RM) is constantly being changed according to the system's requirements. The change in rate matching (ΔRM) is measured in decibels and is calculated according to equation 2.

$$Δ RM = 10 log ( \frac{{RM}_{N}}{{RM}_{o}} ) \qquad Equation 2$$

The corresponding charge in Tₓ power, shown graphically in FIG. 3 as a change in Δ C/I, is then calculated according to equation 3.

$$Δ C / I ( dB ) = \{ \begin{matrix}SxPL ( dB ) & : RM \leq PL \\ SxΔ RM ( dB ) & : PL ⊲ RM \leq {RM}_{max} \\ Δ C / I min & : RM ⊳ {RM}_{max}\end{matrix} \qquad Equation 3$$

When the rate matching uses puncturing the Tₓ power level will be increased according to the slope in the portion of the graph between RM_{O} and PL. Similarly, when the rate matching uses repetition the Tₓ power level will be reduced according to the slope in the portion of the graph between RM_{O} and RMₘₐₓ.

FIG. 4 shows the relevant features of a handset architecture 40 in accordance with a first embodiment of the invention. RF signals are coupled by an antenna 42, which is connected via a duplexer 44 to transmit and receive circuitry 46, 48. The power level of received signals is measured by power level detector 52 after the signals have been filtered and demodulated by filter/demodulator 50. The power level detector provides data to a microprocessor 54 which compensates for rate matching and provides data to power control 56 which, in turn, provides power control data bits. The power control bits are combined with encoded signals prior to, modulation and subsequent transmission via the antenna.

FIG. 5 shows how the invention can be implemented in a base station 70. In the transmit path, after signals have been encoded by encoder 72, the signals are amplified in an amplifier control circuit 74. The amplifier control circuit comprises a power control unit 76, as are typically employed in prior art base stations and a spreading and matching compensation circuit 78. The rate matching and spreading compensation then offsets the power control. The burst then goes through the ordinary transmission and modulation circuits. The antenna 82. The modulator would typically contain signal filters.

As will be appreciated by those skilled in the art, various modifications may be made to the embodiment hereinbefore described without departing from the scope of the present invention. For example, the method of adjusting Tₓ power previously described can be applied due to change in spreading factor. As is well know in FDD type systems, the Tₓ power requirement changes linearly with respect to a change in the spreading factor. For example, if the spreading factor doubles, the Tₓ power requirement is halved. The formula given in equation 1 to calculate the Tₓ power adjustment according to the Midamble size can be used to calculate the Tₓ power adjustment due to the spreading factor in a TDD system.

1. A method for controlling the transmission power in a time division duplex wireless telecommunication system comprising the step of:
adjusting the transmission power of the system according to a relationship between the size of a Midamble signal and the size of a data signal within a transmission burst.

2. A method according to claim 1, wherein said relationship between the size of the Midamble signal (M) and the size of data signal (D) within said transmission burst is a slope (S).

3. A method according to claim 2, wherein:
$$S = \frac{( M - D )}{D} .$$

4. A method according to claims 1-3, wherein the method comprises the further steps of:
determining a change in rate matching (ΔRM) used within said wireless telecommunication system,
determining a puncturing (PL),
determining a minimum transmission power level required to maintain a predetermined ratio of carrier signal power to interference signal power (Δ C/I min), and
calculating a ratio of carrier signal power to interference signal power (Δ C/I ).

5.
$$Δ RM = 10 log ( \frac{{RM}_{N}}{{RM}_{o}} )$$
where:
RM_{O}=initial rate matching value,
RM_{N}=new rate matching value.

6. A method according to claims 4 or 5, wherein:
$$Δ C / I = \{ \begin{matrix}SxPL & : RM \leq PL \\ SxΔ RM & : PL ⊲ RM \leq {RM}_{max} \\ Δ C / I min & : RM ⊳ {RM}_{max}\end{matrix}$$
where: RMₘₐₓ=rate matching value corresponding to Δ C/I min.

7. A method according to claims 4-6, wherein said time division duplex wireless telecommunication system comprises at least one base station and said Δ C/I min value is transmitted from a base station.

8. A method according to claims 4-7, wherein said Δ C/I min value includes a guard level.

9. A method according to claims 4-8, wherein said puncturing, limit (PL) is transmitted from said base station.

10. Apparatus for controlling transmission power in a time d vision duplex wireless telecommunication system including power control means operable to adjust the transmission power of the system according to a relationship between the size of a Midamble signal and the size of a data signal within a transmission burst.

11. Apparatus according to claim 10, wherein said relationship between the size of the Midamble signal (M) and the size of data signal (D) within said transmission burst is a slope (S).

12. Apparatus according to claim 11, wherein:
$$S = \frac{( M - D )}{D} .$$

13. Apparatus according to claims 10-12, wherein the power control means is operable to:
determine a change in rate matching (ΔRM) used within said wireless telecommunication system;
determine a puncturing limit (PL); and,
determine a minimum transmission level power required to maintain a predetermined ratio of carrier signal power to interference signal power (Δ C/I min;,
whereby to calculate a ratio of carrier signal power to interference signal power (Δ C/I ).

14. Apparatus according to claim 13, wherein a base station of the time division duplex wireless telecommunications system is operable to transmit said Δ C/I min value.

15. Apparatus according to claims 13 or 14, wherein said Δ C/I min value includes a guard level.

16. Apparatus according to claims 13-15, wherein said base station is operable to transmit said puncturing limit (PL).
